(19) United States
(12) Patent Application Publication
(10) Pub. No.: US 2026/0326884 A1
(43) Pub. Date: Oct. 22, 2026

(54) WING HATCH AND CONNECTION CHAMBER OF AN AIRCRAFT

(71) Applicant: Airbus Operations (S.A.S.), Toulouse (FR)

(72) Inventors: Caroline Le, Toulouse (FR); François Bignebat, Toulouse (FR); Antonin Perrot, Toulouse (FR); Fanny Pages, Toulouse (FR); Sabina Guilfavona, Toulouse (FR)

(21) Appl. No.: 19/575,106

(22) Filed: Mar. 23, 2026

(30) Foreign Application Priority Data
Mar. 28, 2025 (FR) FR2503217

(51) Int. Cl. B64C 1/26; B64C 1/14

(52) U.S. Cl. CPC B64C 1/26; B64C 1/1446

(57) ABSTRACT

An assembly for an aircraft includes a wing, a chamber for connection of the wing to an aircraft fuselage, and an interface for joining of the chamber to the wing, the chamber including an orifice, known as the chamber orifice, and the wing including an orifice, known as the wing orifice, the chamber orifice and the wing orifice being in the extension of one another.

### TECHNICAL FIELD

The disclosure herein relates to an assembly for an aircraft, comprising a wing, a chamber for connection of the wing to an aircraft fuselage, and hatches for access to the wing and to the chamber.

### BACKGROUND

It is known that the junction between the fuselage of an aircraft and a wing, in particular by a connection chamber, is a critical area in terms of ergonomic constraints on an assembly line of the aircraft. This is the case in particular for an aircraft of the single-aisle type, wherein extremely difficult tasks must be carried out in the chamber by an operator who is in a position which is uncomfortable for carrying out these problematic tasks.

The objective of the disclosure herein is to eliminate these disadvantages at least partly.

### SUMMARY

For this purpose, an assembly for an aircraft is disclosed comprising a wing, a chamber for connection of the wing to an aircraft fuselage, and an interface for joining of the chamber to the wing, the chamber being provided with an orifice, known as the chamber orifice, and the wing being provided with an orifice, known as the wing orifice, the chamber orifice and the wing orifice being in the extension of one another.

Thanks to the assembly according to the disclosure herein, the accessibility to the connection chamber is improved for an operator, who can thus carry out complex tasks, without necessarily entering the chamber, and in an ergonomic position.

According to another aspect, the orifice of the wing is on one or more wing panel(s), optionally in a lower wing surface panel of the aircraft.

According to another aspect, the chamber orifice and the wing orifice extend as far as the joining interface.

According to another aspect, the wing and chamber orifices are closed by a single door.

According to another aspect, the single door comprises a strip produced from elastomer material.

According to another aspect, the wing orifice and part of the chamber orifice are closed by a door, known as the wing door, and the remainder of the chamber orifice is closed by a door, known as the chamber door.

According to another aspect, the wing door comprises a strip produced from elastomer material.

According to another aspect, at least the single door or one or the other of the doors comprises a first door part, known as the inner part, and a second door part, known as the outer part.

The subject of the disclosure herein is also an aircraft, comprising an assembly as previously described.

### BRIEF DESCRIPTION OF THE DRAWINGS

Other characteristics, details and advantages will become apparent from reading the following detailed description, and analyzing the appended drawings, in which:

FIG. 1 is a schematic view in perspective of part of an assembly, for an aircraft, of a wing and a chamber for connection of the wing to the fuse village according to the disclosure herein;

FIG. 2 is a schematic view of a side cross-section of the assembly of FIG. 1 according to a variant embodiment, before assembly of the chamber and the wing;

FIG. 3 is a schematic view of a side cross-section of the assembly of FIG. 1 during the positioning of an outer door;

FIG. 4 is a schematic view of a side cross-section of the assembly of FIG. 1 during joining of the outer door onto an inner door;

FIG. 5 is a schematic view of a side cross-section of a door comprising a strip produced from elastomer material;

FIG. 6 is a schematic view in perspective of the assembly of FIG. 1 according to another embodiment of the disclosure herein;

FIG. 7, FIG. 8, and FIG. 9 illustrate a view in perspective of the assembling of the assembly of FIG. 6 in three steps.

FIG. 10, FIG. 11, FIG. 12, and FIG. 13 are schematic views in transverse cross-section of a sequence of assembling of the assembly of FIG. 6.

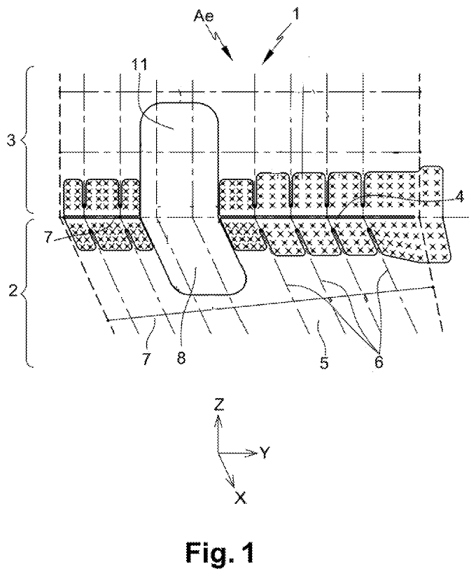

### DETAILED DESCRIPTION

The examples and the associated conditions described here are mainly intended to help the reader understand the principles of the disclosure herein, and not to limit its scope to these specific examples and conditions. It will be understood that persons skilled in the art can conceive of various arrangements that, although not explicitly described or represented here, nevertheless embody the principles of the disclosure herein and are included in its spirit and scope.

Furthermore, in order to facilitate understanding, the following description may describe relatively simplified embodiments of the disclosure herein. As persons skilled in the art will understand, other embodiments of the disclosure herein may be of greater complexity.

In some cases, examples of modifications of the disclosure herein may also be presented. This is done simply as an aid to understanding, and again not to define the scope or establish the limits of the disclosure herein. These modifications are not an exhaustive list, and persons skilled in the art may make other modifications while remaining within the scope of the disclosure herein.

In addition, all the statements hereinafter relating to the principles, aspects and embodiments of the disclosure herein, as well as the specific examples thereof, are intended to encompass both the structural and functional equivalents thereof, whether they are currently known or developed in the future.

As is apparent from the figures, the subject of the disclosure herein is an assembly 1 of a wing 2 and a chamber 3 in order to connect the wing 2 to the fuselage of an aircraft. The assembly 1 also comprises an interface 4 for joining of the wing 2 to the chamber 3.

The subject of the disclosure herein is also an aircraft Ae comprising at least one assembly 1.

The figures represent an orthonormal reference system (X, Y, Z) in order to simplify the interpretation. The axis X is the longitudinal axis of the chamber (parallel to the longitudinal axis of the aircraft), and the axis Y is the transverse axis of the chamber. When the aircraft Ae is on the ground, the axes X and Y are horizontal, and the axis Z is vertical.

The wing 2 comprises an upper panel (not illustrated) and a lower panel 5 which are spaced from one another by ribs 7. One of the ribs forms the interface 4 of joining between the chamber 3 and the wing 2. Strengtheners 6 situated on the lower panel 5 are provided in order to increase its structural rigidity.

The wing 2 comprises an orifice 8 and the chamber comprises an orifice 11 in the extension of one another. The orifices 8 and 11 globally form a single orifice O.

It can be noted that the orifice of the wing is on one or more panels of the wing, and, in the embodiments illustrated, in a lower wing surface panel.

As can be seen in FIG. 6, the orifice O is closed by a chamber door 12 and a wing door 9.

In the position of preparation of the aircraft, the orifices 8 and 11 are open, and the assembly 1 is without the doors 9 and 12. Then, when the assembly 1 is rendered integral with the fuselage of the aircraft, the orifices 8 and 11 are closed by the doors 9 and 12.

The orifices 8 and 11 form passages for access by an operator, who can thus pass via the orifice 8 in order to work in the wing 2, or pass via the orifice 11 in order to work in the chamber 3, without needing to penetrate entirely in the wing or the chamber 3. The orifices 8 and 11 have dimensions suitable for this purpose.

As is apparent from the figures, the orifice 8 and the orifice 11 form two sections of an orifice O, and are separated from one another by the rib 4. The door 12 is interfaced on a part of the orifice 11, and the door 9 is interfaced on part of the orifice 11 and all of the orifice 8.

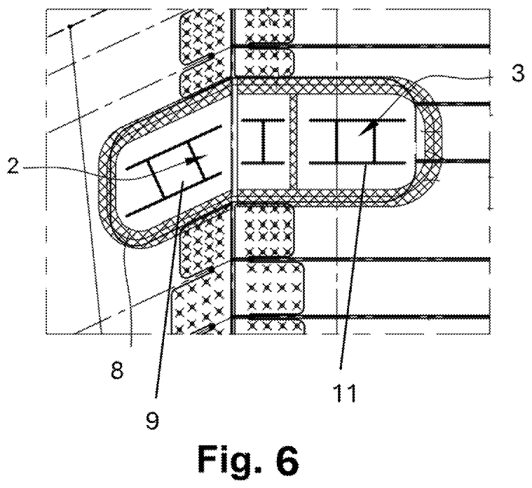

According to a variant illustrated in FIG. 5, the door of the wing 9 comprises a strip 14 which is produced from elastomer material. The elastomer strip 14 ensures flexibility of the door 9, which prevents generation of stresses in the door during movements of flexure of the wing in relation to the chamber.

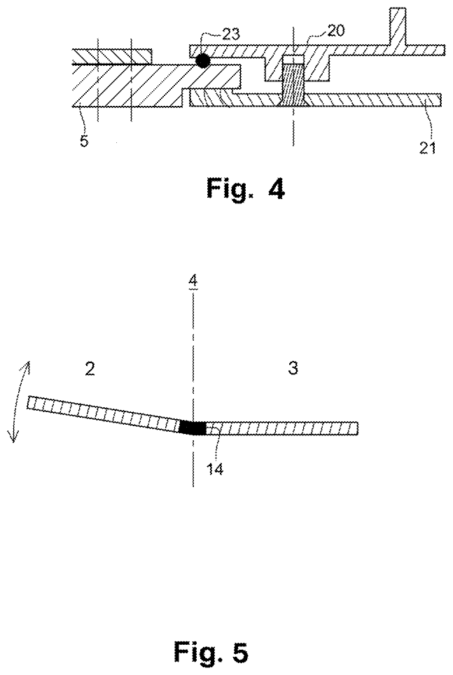

Each door is composed of an inner part 20 and an outer part 21, as illustrated in FIG. 4. A solid sealing element 23 is situated on the inner part 20 of the door. The arrangement of the inner part of the door is such that the fuel which is contained in the wing and the chamber tends to maintain the door closed by the pressure which it exerts thereon.

A description is provided of the steps of installation of the inner 20 and outer 21 parts, for example once the tasks to be carried out have been performed by an operator.

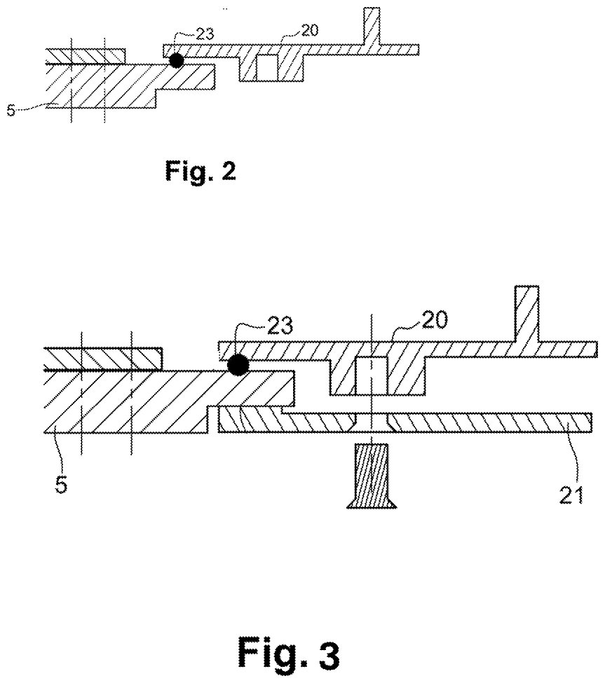

Firstly, the inner part 20 is positioned on the panel 5, such that the solid sealing element 23 is in direct contact with the panel 5, and thus ensures the sealing between the lower part 20 and the panel 5 of the wing 2, as shown in FIG. 2. The outer part 21 is then positioned in relation to the inner part 20. Once it is in position, the outer part 21 is bolted on the inner part 20, as illustrated in FIG. 3.

FIG. 4 illustrates a section of the final condition of the door after installation. The door is maintained in position on the panel by clamping during the bolting of the outer part 21 on the inner part 20.

The sealing against the fuel contained in the interior of the chamber and the wing is obtained by compression of the sealing element on the panel.

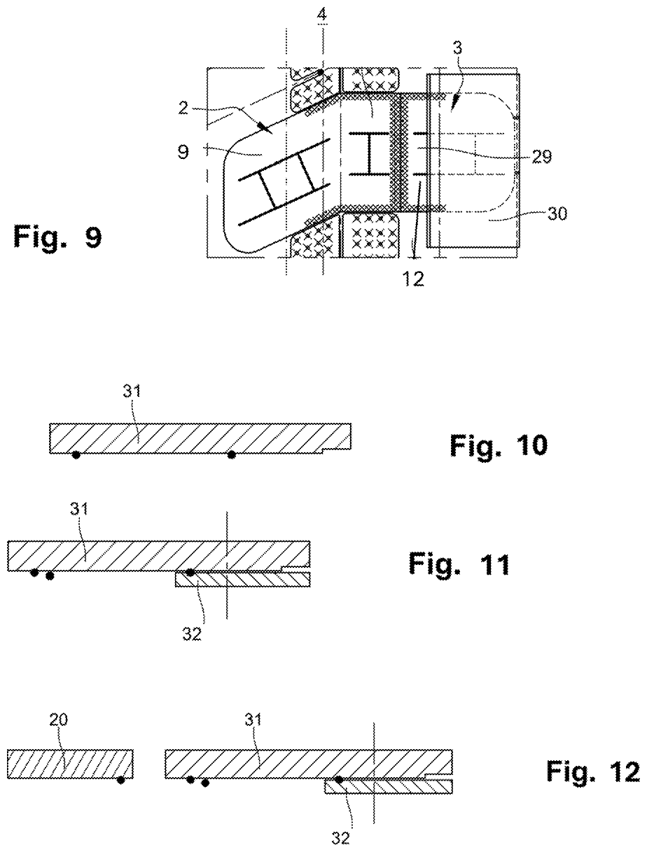

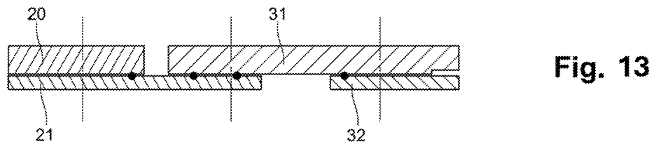

An installation alternative is illustrated in FIGS. 10 to 13, where the orifice O is blocked by the doors 9 and 12 which are interfaced on one another. The inner part, with the reference 31, of the chamber door 14 is put into position in the orifice O. Then, the outer part 32 of the chamber door is “joined”, i.e. rendered integral with, the inner part 31 of the chamber door. Then, the inner part 20 of the wing door 9 is put into position. Finally, the outer part 21 is “joined” with the inner parts 20 and 31 respectively of the wing and chamber doors.

A door alternative would consist of closing the orifice by a single door containing the flexible strip 14.

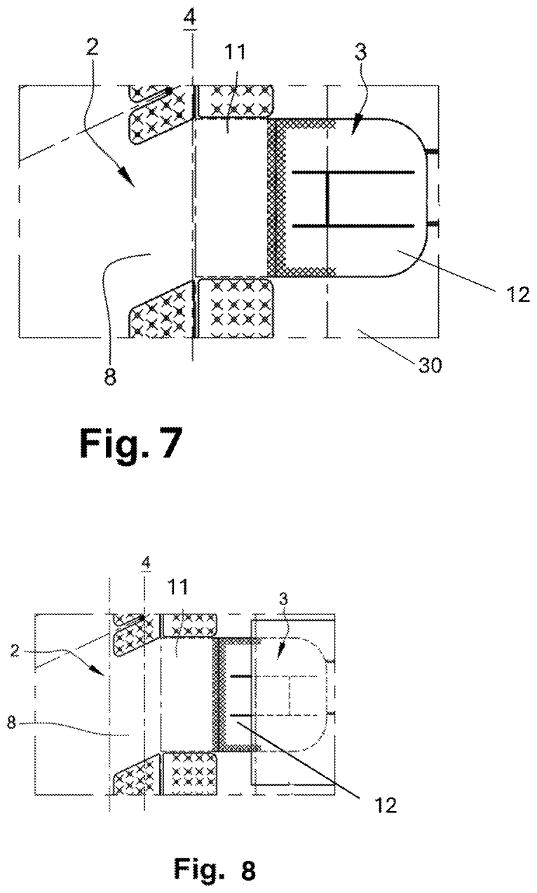

According to an installation variant illustrated in FIGS. 7 to 9, the door chamber 12 is installed during the assembly of the chamber (FIG. 7) in order to permit the installation of a system module 30 situated below the chamber (FIG. 8). The wing is then “joined” with the fuselage, then the wing door 9 is installed.

Modifications and improvements to the embodiments described above of the disclosure herein may be apparent to persons skilled in the art. In particular, the embodiments and variants described can be combined provided that they are not incompatible. The above description is illustrative by examples rather than being limiting. The scope of the disclosure herein is therefore limited solely by the scope of the following claims.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An assembly for an aircraft comprising a wing, a chamber for connection of the wing to an aircraft fuselage, and an interface for joining of the chamber to the wing, the chamber comprising a chamber orifice, and the wing comprising a wing orifice, the chamber orifice and the wing orifice being in an extension of one another.

2. The assembly according to claim 1, wherein the chamber orifice and the wing orifice extend as far as the interface for joining.

3. The assembly according to claim 1, wherein the wing and chamber orifices are closed by a single door.

4. The assembly according to claim 3, wherein the single door comprises a strip produced from elastomer material.

5. The assembly according to claim 1, wherein the wing orifice and part of the chamber orifice are closed by a wing door, and a remainder of the chamber orifice is closed by a chamber door.

6. The assembly according to claim 5, wherein the wing door comprises a strip produced from elastomer material.

7. The assembly according to claim 3, when at least the single door, or one of others of the doors, comprises a first door inner part, and a second door outer part.

8. An aircraft comprising the assembly according to claim 1.
